(19) United States
(12) Patent Application Publication
(10) Pub. No.: US 2022/0220778 A1
(43) Pub. Date: Jul. 14, 2022

(54) ZIPPER LOCK

(71) Applicant: The Betr Company Inc., Los Angeles, CA (US)

(72) Inventors: Justin MEIN, Los Angeles, CA (US); Jeffrey Alan LARSEN, Los Angeles, CA (US)

(73) Assignee: The Betr Company, Inc., Los Angeles, CA (US)

(21) Appl. No.: 17/575,937

(22) Filed: Jan. 14, 2022

Related U.S. Application Data
(60) Provisional application No. 63/137,391, filed on Jan. 14, 2021.

(51) Int. Cl. E05B 65/52; A45C 13/18

(52) U.S. Cl. CPC E05B 65/52; A45C 13/18

(57) ABSTRACT

Described herein is a zipper lock apparatus suitable for locking one or two zipper pulls such as are used for the opening and closing of various compartments of luggage, handbags, diaper bags and so on, as will be known to one of ordinary skill in the art. It is an object of the invention to prevent unauthorized access to the contents thereof such as by small children or persons intending to steal the contents, or add undesirable contents. Illustrative embodiments include housings equipped with means for securing one or two zipper pulls, such as carabiners, with means for locking the housings together once the carabiners have secured the one or two zipper pulls, although other securement means are possible. A zipper lock apparatus as described herein may be of various shapes and sizes suitable for various use applications, so long as one or two zipper pulls may be secured.

### CROSS-REFERENCE TO RELATED APPLICATIONS

The present application claims priority to and the benefit of U.S. Provisional Patent Application No. 63/137,391, filed Jan. 14, 2021, the contents of which are hereby incorporated in their entirety.

### BACKGROUND OF THE INVENTION

People who have (or once had) small children, such as from infants to children three years of age, will understand a need in the art for a means for preventing these children from accessing their personal belongings or other materials to which access prevention is desirable. All too frequently these small children will gain access to their parents' handbags, briefcases, diaper bags or other accessories or luggage containing materials that are not appropriate for children to access. Some such accessories or luggage items may contain locking mechanisms, but in particular bags with zippers may not be equipped with a means to prevent children from accessing their contents. Thus, there is a long felt need in the art for a locking mechanism for bags with zippers that prevents small children from accessing the contents while enabling adults to easily lock and unlock the bags as needed, without, for example, using a key or combination lock.

### SUMMARY OF THE INVENTION

The invention is that of a zipper lock as described throughout the disclosure, exemplary embodiments of which are illustrated in the accompanying drawings. It is one object of the present invention to keep small children out of diaper bags, which they have a tendency to open too frequently. However, the invention has more general applicability to most bags with zippers, and in particular zippers with two sliders that may be locked together using a device as described herein.

A zipper lock according to the present invention is suitable for locking one or two sliders in place such that small children may not move the sliders to access a bag having zippers as a means for opening and closing, while at the same time enabling easy opening by any adult with proper finger strength and dexterity to easily access and reseal. Unlike traditional zipper pulls, the present invention includes a locking mechanism that may be easily opened and closed by depressing a button to activate and deactivate a clasp for locking the system. Embodiments of the invention may be applicable to backpacks for public transit passengers, for example, helping to prevent theft or otherwise unauthorized access to personal items. The invention may be useful in deterring thieves inasmuch as a zipper lock as described herein may not have been encountered before and as such a thief may perceive that the amount of time to access the bag having the zipper lock would be unacceptably long and thus move on to another target not having such a lock.

### BRIEF DESCRIPTION OF THE DRAWINGS

FIG. 1 is a top front isometric view an illustrative embodiment of a zipper lock as described and claimed herein, configured with a single button, in its locked position.

FIG. 2 is a top rear isometric view of the embodiment of FIG. 1 in its locked position.

FIG. 3 is a front view of the embodiment of FIG. 1 in its locked position.

FIG. 4 is a rear view of the embodiment of FIG. 1 in its locked position.

FIG. 5 is a left view of the embodiment of FIG. 1.

FIG. 6 is a right view of the embodiment of FIG. 1.

FIG. 7 is a top view of the embodiment of FIG. 1 in its locked position.

FIG. 8 is a bottom view of the embodiment of FIG. 1 in its locked position.

FIG. 9 is a top front isometric view of the embodiment of FIG. 1 in its open position.

FIG. 10 is a top front isometric view an illustrative embodiment of a zipper lock as described and claimed herein, configured with two buttons, in its locked position.

FIG. 11 is a top rear isometric view of the embodiment of FIG. 10 in its locked position.

FIG. 12 is a front view of the embodiment of FIG. 10 in its locked position.

FIG. 13 is a rear view of the embodiment of FIG. 10 in its locked position.

FIG. 14 is a left view of the embodiment of FIG. 10.

FIG. 15 is a right view of the embodiment of FIG. 10.

FIG. 16 is a top view of the embodiment of FIG. 10 in its locked position.

FIG. 17 is a bottom view of the embodiment of FIG. 10 in its locked position.

FIG. 18 is a top front isometric view of the embodiment of FIG. 10 in its open position.

### DETAILED DESCRIPTION OF THE INVENTION

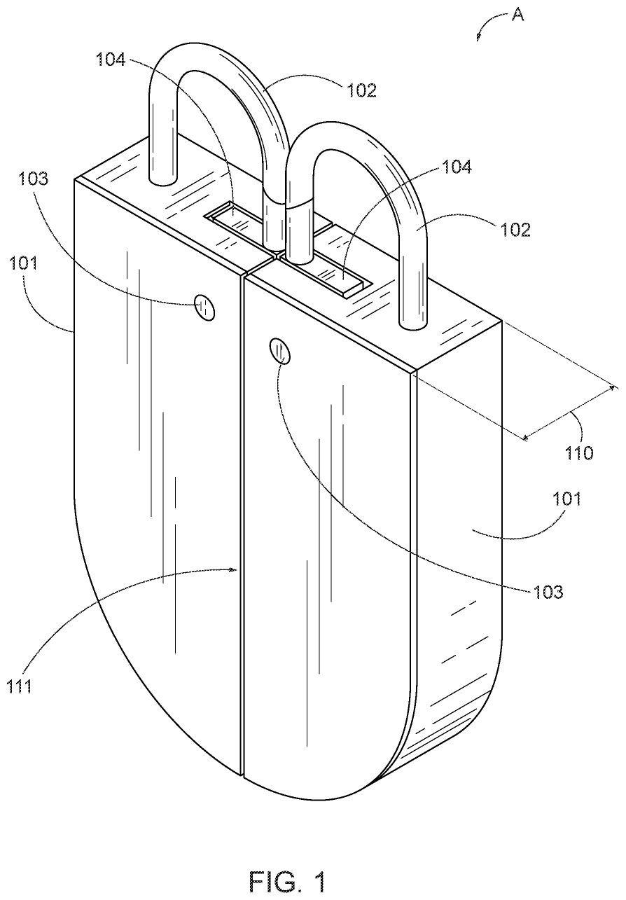

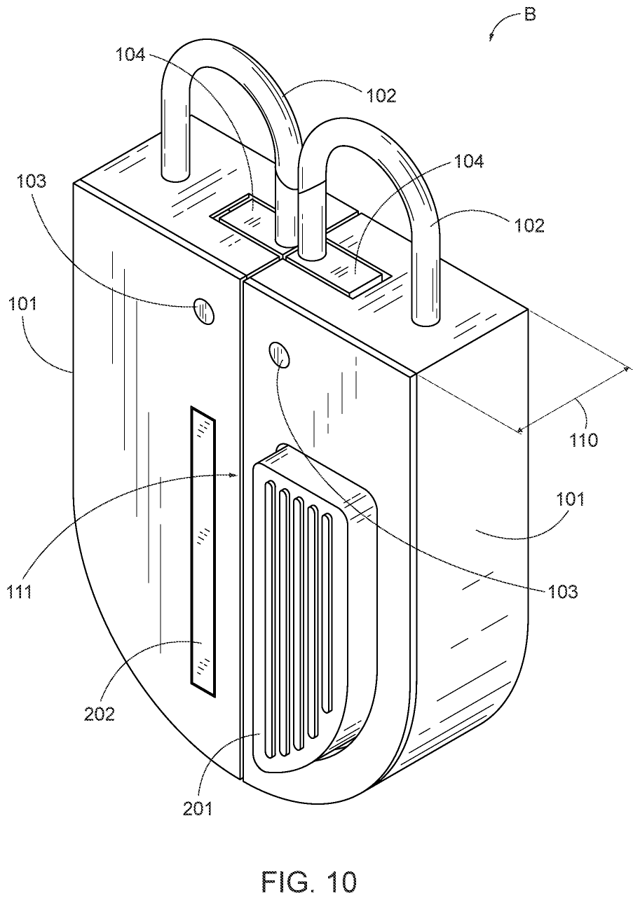

The invention of a zipper lock as described throughout the present disclosure is best described with reference to the exemplary embodiments illustrated in the accompanying drawings. An illustrative embodiment with a single button for actuating the locking and unlocking of a zipper lock as described herein is shown in the various views presented in FIGS. 1-9. An alternative embodiment having two buttons for actuating the locking and unlocking of a zipper lock as described herein is illustrated in the views shown as FIGS. 10-18. Other embodiments are plausible, as will be recognized by one of ordinary skill in the art, each having general applicability to most bags or similar articles figured with zipper closures, and in particular zippers with two sliders that may be locked together using a device as described herein.

Turning now to the illustrative embodiments presented herein, FIG. 1 illustrates a top front isometric view of an embodiment A of a zipper lock as described and claimed herein in its locked position. As can be seen in FIG. 1, a zipper lock as described herein comprises two housings 101 that may be locked together and unlocked as described in further detail below. A carabiner 102 is attached to the top of each housing such that it is capable of rotating slightly inward (i.e., toward the opposite housing) when light pressure is applied to the outside of the carabiner 102 causing the carabiner 102 to rotate about an axis defined by a thin rod 103 spanning a thickness 110 of a housing 101 passing through a nut 104 into which the end of the carabiner 102 nearest the interface 111 between the two housings 102 is inserted.

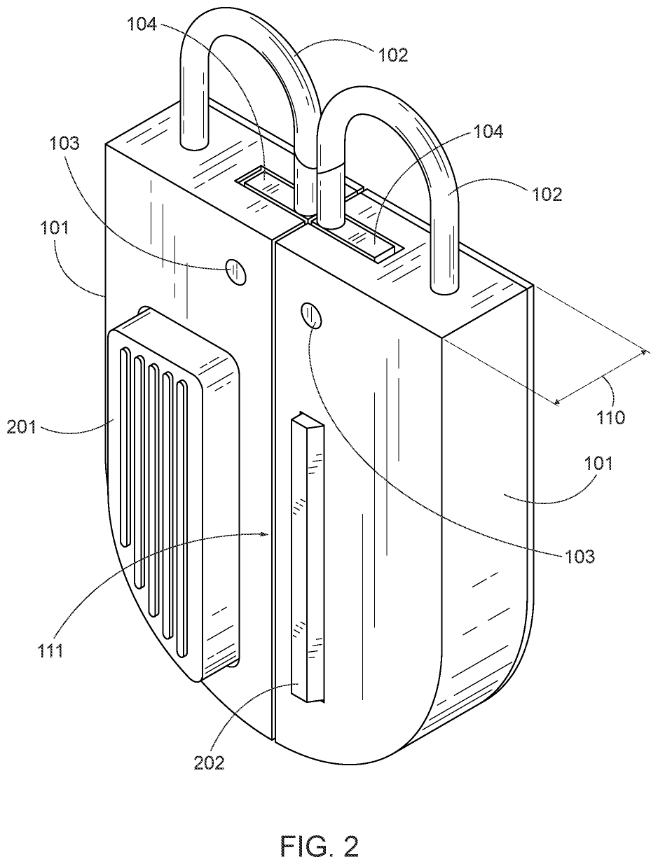

FIG. 2 illustrates a top rear isometric view of the embodiment of FIG. 1 in its locked position. A button 201 connected to a deadbolt 202 is configured such that when the button 201 is depressed, the deadbolt 202 is depressed to enable unlocking of the housings 101 from one another.

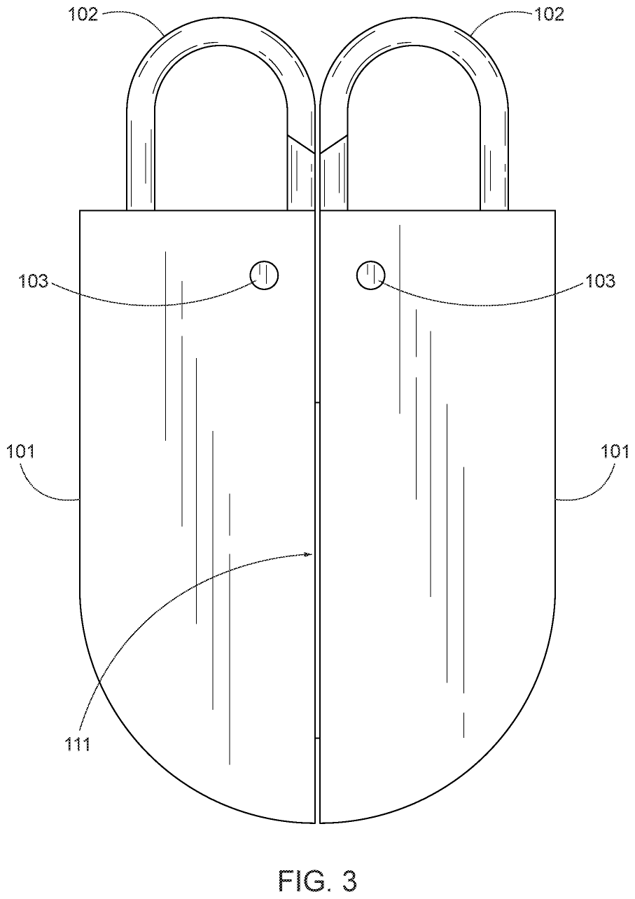

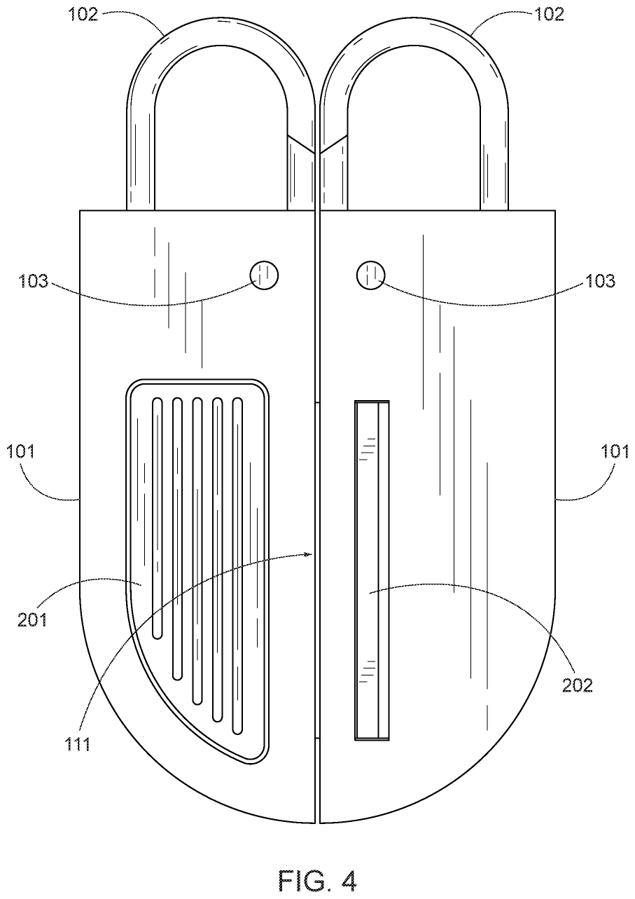

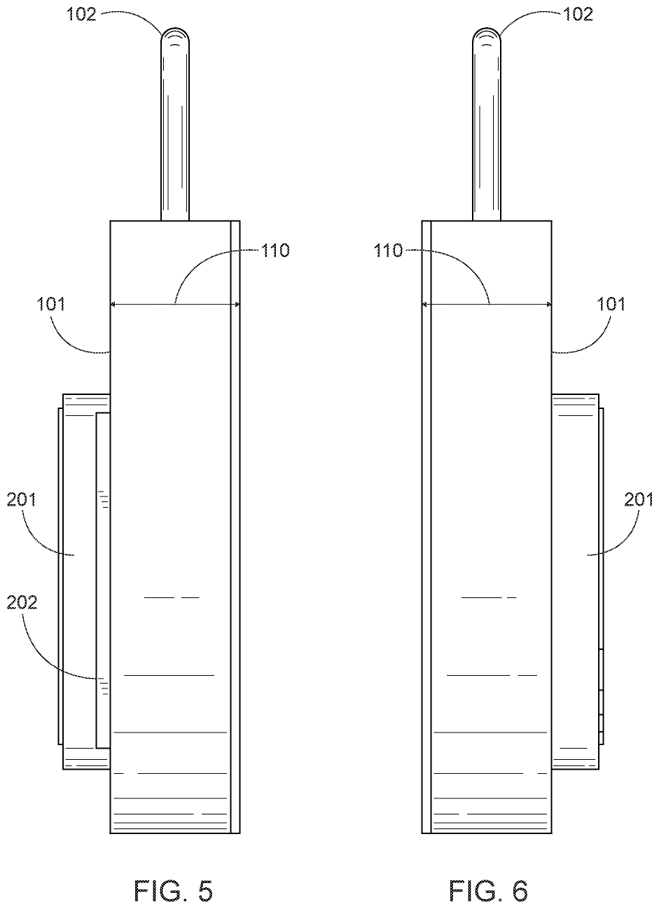

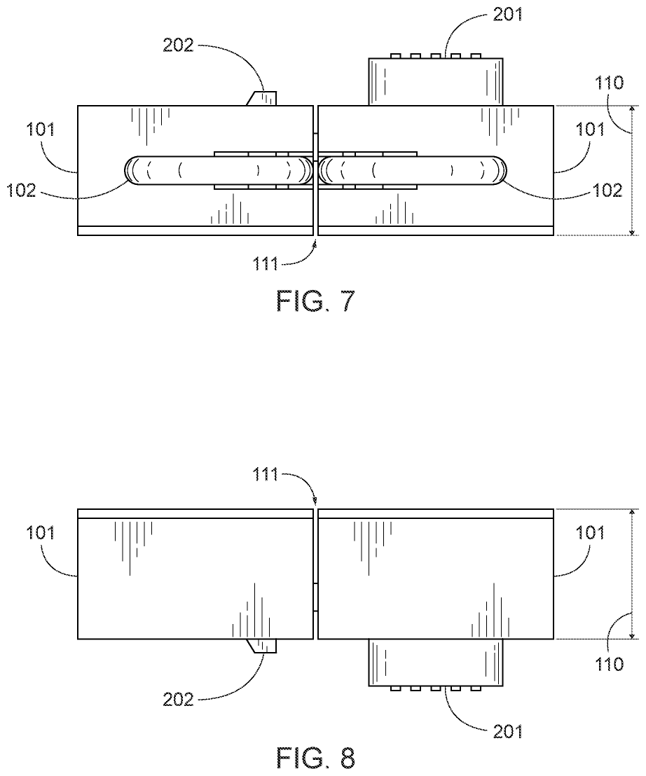

Front and rear views of the embodiment of FIG. 1 in its locked position are illustrated in FIGS. 3 and 4, respectively, with the button 201 and deadbolt 202 set in the locked position as shown in FIG. 4. Left and right side views of the same are shown in FIGS. 5 and 6, respectively. Top and bottom views of the same are shown in FIGS. 7 and 8, respectively.

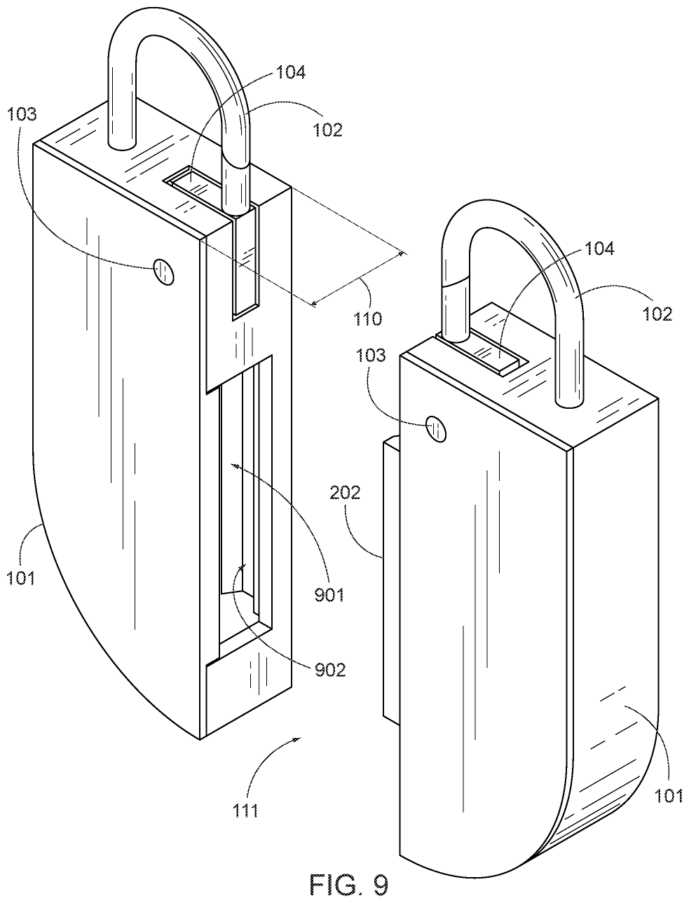

Turning to FIG. 9, a top front isometric view of the illustrative embodiment of FIG. 1 is shown in its open position to illustrate in further detail the function of the zipper lock according to FIG. 1. The housing 101 on the left side of the drawing comprises a cavity 901 into which a deadbolt 202 may be inserted when button 201 is depressed and the housings 101 are moved together at interface 111, then when button 201 is released, deadbolt 202 protrudes through a lock bore 902 on the rear face of the housing 101 on the left of the drawing.

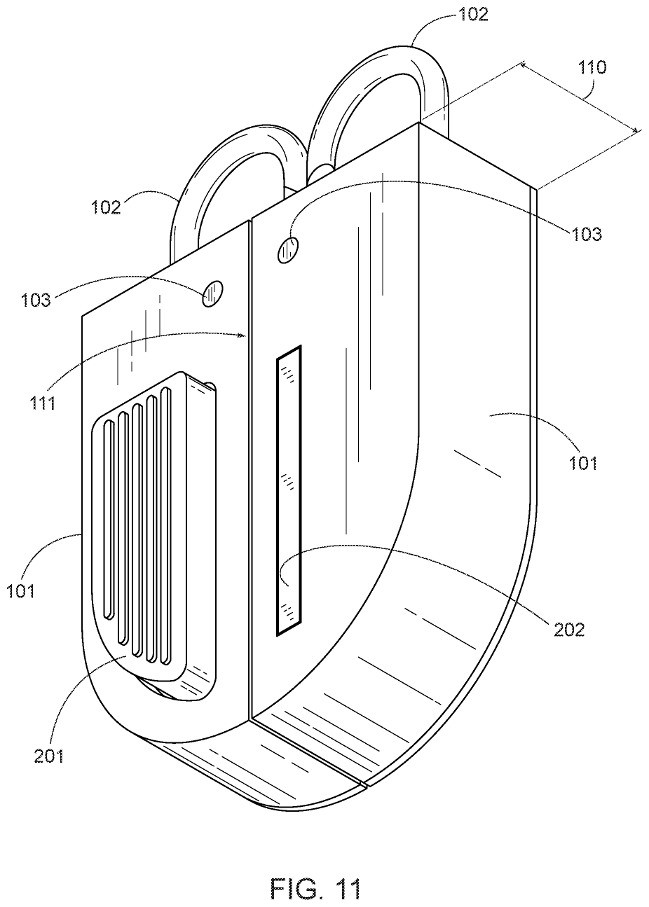

An alternate embodiment of a zipper lock according to the present disclosure is illustrated in FIGS. 10-18, with FIG. 10 illustrating a top front isometric view of the embodiment B and FIG. 11 illustrating a top rear isometric view of the same, which is configured with two buttons, in its locked position. As can be seen in FIGS. 10 and 11, a zipper lock according to this embodiment comprises two housings 101 that may be locked together and unlocked as described in further detail below. A carabiner 102 is attached to the top of each housing such that it is capable of rotating slightly inward (i.e., toward the opposite housing) when light pressure is applied to the outside of the carabiner 102 causing the carabiner 102 to rotate about an axis defined by a thin rod 103 spanning a thickness 110 of a housing 101 passing through a nut 104 into which the end of the carabiner 102 nearest the interface 111 between the two housings 102 is inserted. In this embodiment, two buttons 201 each connected to a deadbolt 202 is configured such that when a button 201 is depressed, the corresponding deadbolt 202 is depressed to enable unlocking of the housings 101 from one another.

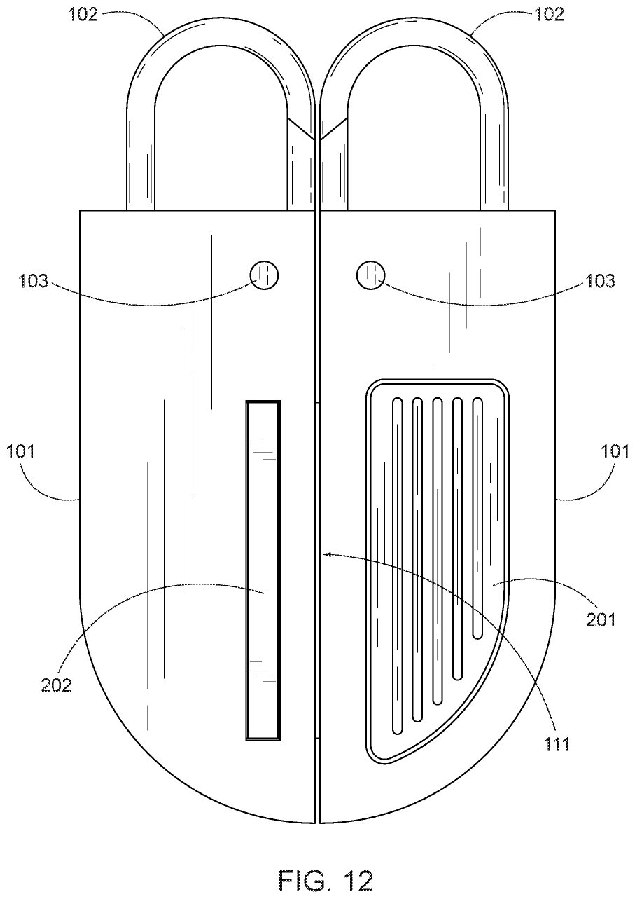

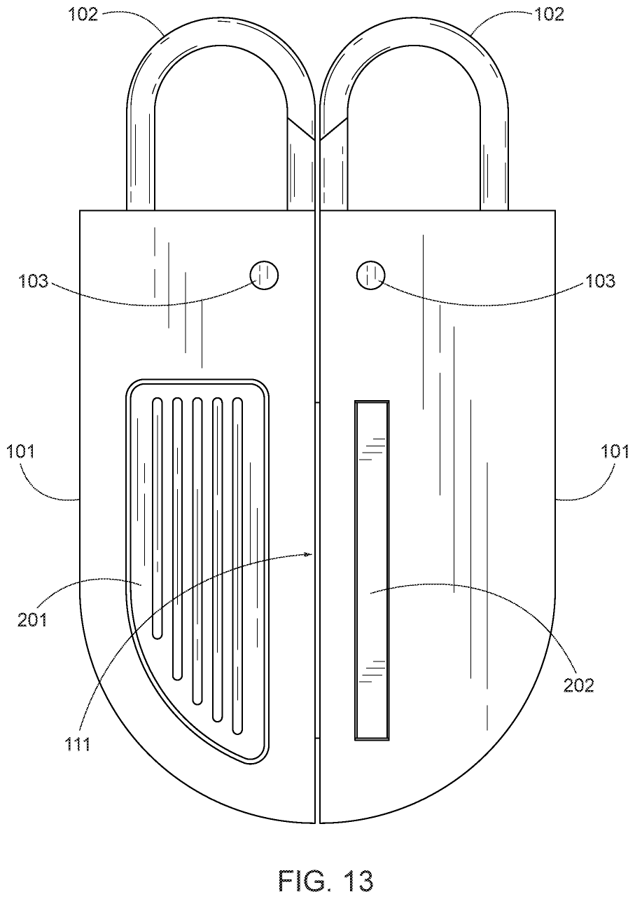

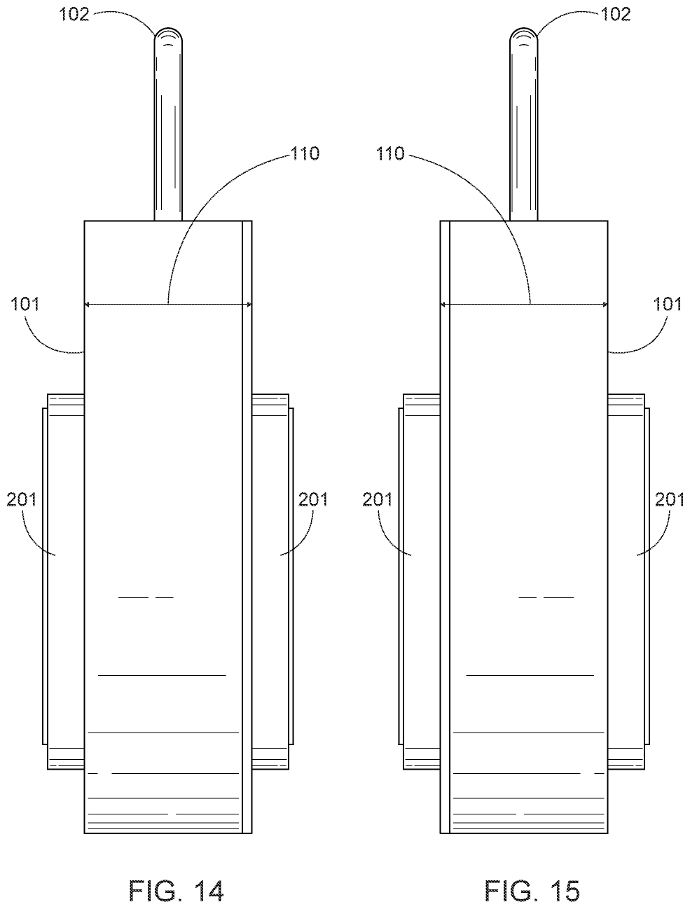

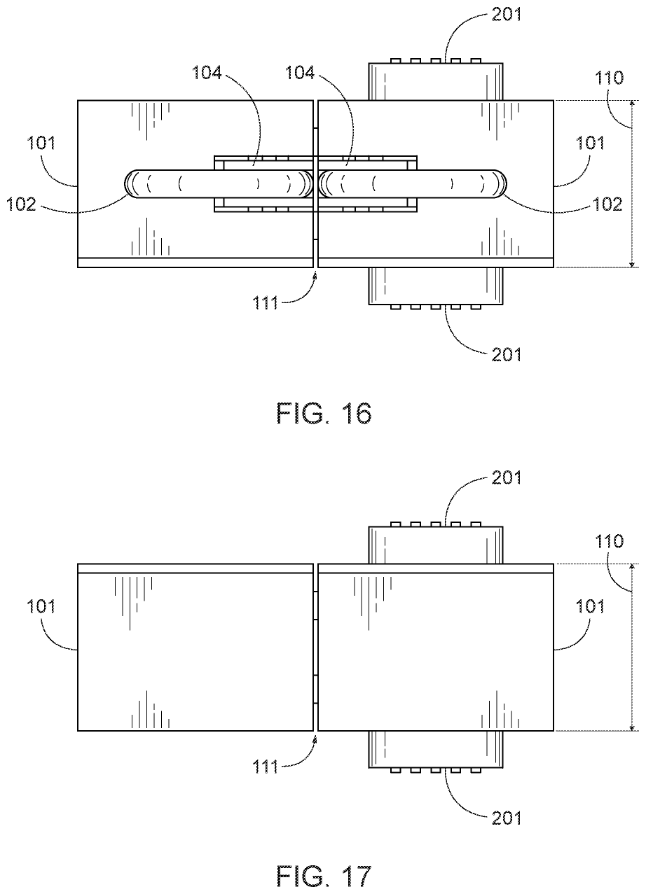

Front and rear views of embodiment B in its locked position are illustrated in FIGS. 12 and 13, respectively, with the button 201 and deadbolt 202 set in the locked position. Left and right side views of the same are shown in FIGS. 14 and 15, respectively. Top and bottom views of the same are shown in FIGS. 16 and 17, respectively.

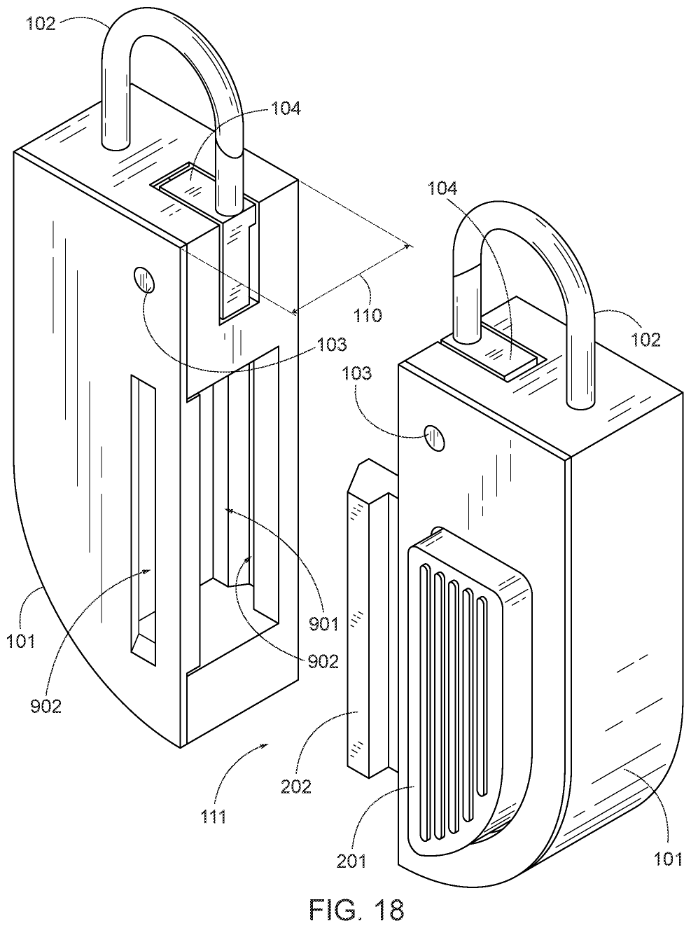

Turning to FIG. 18, a top front isometric view of illustrative embodiment B is shown in its open position to illustrate in further detail the function of the zipper lock according to FIGS. 10 and 11. The housing 101 on the left side of the drawing comprises a cavity 901 into which a deadbolt 202 may be inserted when button 201 is depressed and the housings 101 are moved together at interface 111, then when button 201 is released, deadbolt 202 protrudes through a lock bore 902 on the rear face of the housing 101 on the left of the drawing. The same features and functionality, although not shown, are present on the reverse side of the view, with the button and deadbolt being configured on opposite housings, as one of ordinary skill in the art will appreciate when considering FIG. 18 in view of FIGS. 10 and 11.

It will be appreciated by one of ordinary skill in the art that while the illustrative embodiments of the drawings of the present disclosure show the faces of each housing being configured as a rectangle with a substantially semi-circular or rounded end, other configurations are possible.

For example, carabiners need not be used exclusively as the means for securing two zipper pulls together, or a single zipper pull to another part of a bag for locking. Not only that, but where carabiners are used, they need not be presented in a horseshoe shaped configuration as they are in the illustrative embodiments of the accompanying drawings, not do they need to rotate inward as described above. Rather, the nut described herein could be absent from alternative embodiments and each carabiner could rotate outward from a top surface of a housing to then be secured to a zipper pull and rotated back inward.

The housings illustrated in the drawings may take multiple shapes and need not be presented as rectangular with substantially rounded edges as they are in the illustrative embodiments of the drawings. Additionally, but buttons and deadbolts may be configured in different sizes and shapes, so long as they comprise a locking means securing the housings together once the one or more zipper pulls as described herein have been secured. Indeed, one of ordinary skill in the art could envision a configuration where a locking and unlocking means such as a button and deadbolt combination could appear on the side of each housing rather than the front or rear face. Additionally, the deadbolt could be replaced with a hook or clasp suitable for locking the housings together. These and other possible configurations will be readily appreciated by one of ordinary skill in the art.

What is claimed:

1. A zipper lock for preventing unauthorized access to the contents of a luggage comprising a zipper, the zipper lock consisting essentially of a means of securing a first zipper pull of the zipper to a member of the group consisting of a second zipper pull or a stationary object of the luggage.

2. A zipper lock for preventing unauthorized access to the contents of a luggage comprising a zipper, the zipper lock comprising:
a first housing configured with a first carabiner and a second housing configured with a second carabiner, wherein each carabiner is configured to be inserted into a zipper pull or equivalent;
wherein the first housing comprises a button for locking and releasing a first deadbolt within a cavity of the second housing, wherein the first housing is locked to the second housing when the first deadbolt is locked within the cavity of the second housing.

3. The zipper lock of claim 2, wherein the first carabiner and second carabiner may not be pulled apart when the deadbolt is locked within the cavity.

4. The zipper lock of claim 3, wherein each of the first carabiner and the second carabiner are inserted to a zipper pull or equivalent such that each zipper pull or equivalent are locked together.

5. The zipper lock of claim 3, wherein each of the first carabiner and the second carabiner are configured with a nut recessed within the top of each corresponding housing, wherein each nut rotates about an axis defined by a rod spanning the thickness of the corresponding housing and allows each carabiner to be inserted into a zipper lock or equivalent.

6. The zipper lock of claim 2, wherein the second housing comprises a button for locking and releasing a second deadbolt within a cavity of the first housing, wherein the first housing is locked to the second housing when the first deadbolt is locked within the cavity of the second housing and the second deadbolt is locked within the cavity of the first housing.

7. The zipper lock of claim 6, wherein each of the first carabiner and the second carabiner are inserted to a zipper pull or equivalent such that each zipper pull or equivalent are locked together.

8. A method of preventing unauthorized access to the contents of a luggage, the method comprising providing a zipper lock according to claim 1 and securing a first zipper pull of a zipper of the luggage to a member of the group consisting of a second zipper pull or a stationary object of the luggage.

9. A method of preventing unauthorized access to the contents of a luggage, the method comprising providing a zipper lock according to claim 3, inserting each carabiner is into a zipper pull or equivalent of the luggage, locking the first deadbolt within the cavity of the second housing.

10. A method of preventing unauthorized access to the contents of a luggage, the method comprising providing a zipper lock according to claim 5, inserting each carabiner is into a zipper pull or equivalent of the luggage, locking the first deadbolt within the cavity of the second housing.

11. A method of preventing unauthorized access to the contents of a luggage, the method comprising providing a zipper lock according to claim 6, inserting each carabiner is into a zipper pull or equivalent of the luggage, locking the first deadbolt within the cavity of the second housing and locking the second deadbolt within the cavity of the first housing.
